(19) United States
(12) Patent Application Publication
(10) Pub. No.: US 2026/0186919 A1
(43) Pub. Date: Jul. 2, 2026

(54) DEDICATED CHANNELS FOR DATA TRANSMISSION

(71) Applicant: Micron Technology, Inc., Boise, ID (US)

(72) Inventors: Scott E. Schaefer, Boise, ID (US); Frank F. Ross, Boise, ID (US); Randall J. Rooney, Boise, ID (US); Navid Lashkarian, Pleasanton, CA (US); Matthew A. Prather, Boise, ID (US)

(21) Appl. No.: 19/429,861

(22) Filed: Dec. 22, 2025

Related U.S. Application Data
(60) Provisional application No. 63/740,250, filed on Dec. 30, 2024.

(51) Int. Cl. G06F 11/16; G06F 11/10

(52) U.S. Cl. CPC G06F 11/1629; G06F 11/1004

(57) ABSTRACT

Methods, systems, and devices for dedicated channels for data transmission are described. A receiving device may receive, from a transmitting device, first data via a first channel and second data via a second channel (e.g., a redundant channel). The receiving device may perform one or more error control operations on the first data and the second data, and may select a channel for additional communications if one or more errors are detected in the data. The receiving device may also select a channel if the channel is indicated by a stored parameter. In some examples, the receiving device may transmit feedback in third data via the first channel, via the redundant channel, or both, which may be used by a transmitting device to detect or correct one or more errors, or for training operations.

### CROSS REFERENCE

The present Application for Patent claims priority to U.S. Patent Application No. 63/740,250 by Schaefer et al., entitled “DEDICATED CHANNELS FOR DATA TRANSMISSION,” filed Dec. 30, 2024 which is assigned to the assignee hereof, and which is expressly incorporated by reference in its entirety herein.

### TECHNICAL FIELD

The following relates to one or more systems for memory, including dedicated channels for data transmission.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports dedicated channels for data transmission in accordance with examples as disclosed herein.

FIG. 2 shows an example of a system that supports dedicated channels for data transmission in accordance with examples as disclosed herein.

FIG. 3 shows an example of a system that supports dedicated channels for data transmission in accordance with examples as disclosed herein.

FIG. 4 shows an example of a system that supports dedicated channels for data transmission in accordance with examples as disclosed herein.

FIG. 5 shows a block diagram of a memory system or a host system that supports dedicated channels for data transmission in accordance with examples as disclosed herein.

FIGS. 6 and 7 show flowcharts illustrating a method or methods that support dedicated channels for data transmission in accordance with examples as disclosed herein.

### DETAILED DESCRIPTION

Devices (e.g., transmitting devices, receiving devices, host systems, modules, memory systems, memory devices) may communicate signaling using one or more channels coupled with respective pins. For example, a host system may communicate data with one or more modules (e.g., one or more memory systems or memory devices) using one or more channels coupled with a respective pin (or pins), including command/address (CA) signaling via a CA channel and data via a data (DQ) channel. In some examples, data communicated via one or more channels may include or otherwise be associated with one or more errors. For example, a memory system may receive and store data transmitted by a host system, where the error(s) in the data may be caused by the channel or method of transmission (e.g., due to interference from other electrical or wireless signaling, due to imperfections or damage in the channels or pins of devices), among other factors. In some cases, errors may be caused by a faulty or otherwise defective channel (e.g., a faulty or otherwise defective pin), resulting in the associated operation being unsuccessful. In such instances, as the system may experience an increase in latency in communications due the faulty data being retransmitted. Thus, it may be desirable to increase the reliability in communications between devices.

Techniques described herein may support dedicated channels between one or more devices (e.g., dedicated communication channels) to improve reliability in communications between devices. For example, a receiving device (e.g., a module, a memory system) may receive first data (e.g., data for a CA signal, for a DQ signal) transmitted via a first channel (e.g., a CA channel, a DQ channel) and may receive second data, which may be redundant data (e.g., redundant to the first data) via a second channel (e.g., a redundant channel). The receiving device may perform one or more error control operations on the first data and second data, and may select a channel for additional communications if one or more errors are detected in the data. Additionally, or alternatively, the receiving device may select a channel for data transmission based on one or more parameters (e.g., bits, values) stored at the receiving device. In some examples, the receiving device may transmit feedback using one of the channels, which may be used by a transmitting device to detect or correct one or more errors, for training operations, or both. Further, the receiving device may support multiplexing data for multiple channels over a single channel if one or more other channels experience failures in communications (e.g., if a threshold quantity of errors are detected in communications over other channels). In some cases, the receiving device may support reporting whether one or more errors are detected, and may identify a failed pin associated with detected errors. Further, devices may support added redundancy via use of cyclic redundancy check (CRC) bits or parity bits in transmitted data, or via error detection and correction at the receiving device or at the transmitting device.

Including a redundant channel between devices may increase information reliability by providing a secondary method (e.g., a backup method) for communicating data, as well as providing for relatively faster error detection. Additionally, by transmitting feedback, information reliability may be increased by performing error control at a transmitting device while providing opportunities for further training (e.g., write leveling, DQ strobe training, etc.). Error correction using CRC or parity bits may further increase reliability of a channel by providing added redundancy. Further, multiplexing channel information on a single channel may enable communication in the case of failed channels.

In addition to applicability in memory systems as described herein, techniques relating to utilizing dedicated channels for data transmission may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by increasing information reliability and increasing a detection rate of errors by using redundant channels, resulting in improved performance by correcting and reducing errors in information exchanged with one or more modules, and reducing latency due to retransmissions of failed data, among other benefits.

In addition to applicability in memory systems as described herein, techniques relating to utilizing dedicated channels for data transmission may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by providing redundant channels among other methods to mitigate pin failures, which may extend the life of electronic devices and thereby reduce electronic waste, among other benefits.

Features of the disclosure are illustrated and described in the context of systems and architectures. Features of the disclosure are further illustrated and described in the context of systems, block diagrams, and flowcharts.

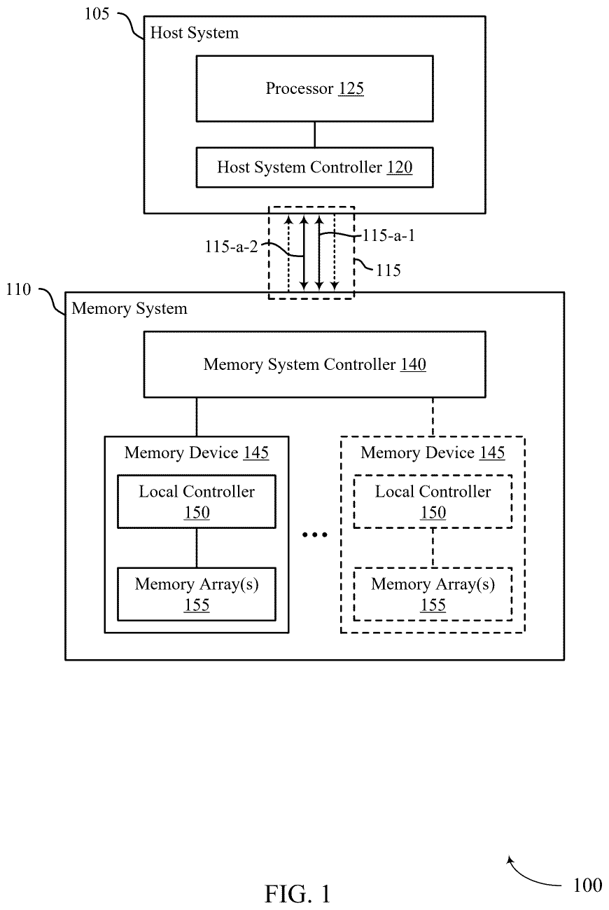

FIG. 1 shows an example of a system 100 that supports dedicated channels for data transmission in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

Signaling may be communicated over the channels 115 using single data rate (SDR) signaling or double data rate (DDR) signaling, among other rates (e.g., relative to a clock signal). In SDR signaling, one modulation symbol (e.g., signal level) of a signal may be registered for each clock cycle (e.g., on a rising edge or a falling edge of a clock signal). In DDR signaling, two modulation symbols of a signal may be registered for each clock cycle (e.g., on both a rising edge and a falling edge of a clock signal).

Signals communicated over the channels 115 may be modulated using various modulation schemes or combinations thereof. A symbol of a binary-symbol (e.g., binary-level) modulation scheme may be operable to represent one bit of data (e.g., a symbol may represent a logic 1 or a logic 0), and may be an example of an M-ary modulation scheme where M is equal to two. Examples of binary-symbol modulation schemes include non-return-to-zero (NRZ), unipolar encoding, bipolar encoding, Manchester encoding, pulse amplitude modulation (PAM) having two symbols (e.g., PAM2), and others. A symbol of a multi-symbol modulation scheme may be operable to represent more than one bit of data (e.g., a symbol may represent a logic 00, a logic 01, a logic 10, or a logic 11), and may be an example of an M-ary modulation scheme where M is greater than or equal to three. For example, a multi-symbol signal may be modulated using a modulation scheme that includes at least three levels to encode more than one bit of information. Multi-symbol modulation schemes and symbols may be referred to as non-binary, multi-bit, or higher-order modulation schemes and symbols. Examples of multi-symbol modulation schemes include PAM3, PAM4, PAM8, and so on, quadrature amplitude modulation (QAM), quadrature phase shift keying (QPSK), and others.

In some examples, the system 100 may support dedicated channels in one or more devices (e.g., dedicated communication channels) as described herein. For example, a receiving device (e.g., a memory system 110, a host system 105) may receive first data (e.g., data for a CA signal, for a DQ signal) transmitted via a channel 115-a-1 (e.g., a CA channel, a DQ channel) and may receive second data, which may be redundant data (e.g., redundant to the first data) via a via a channel 115-a-2 (e.g., a redundant channel). The receiving device may perform one or more error control operations on the first data and second data, and may select a channel 115 for additional communications if one or more errors are detected in the data. Additionally, or alternatively, the receiving device may select a channel 115 for data transmission based on one or more parameters (e.g., bits, values) stored at the receiving device. In some examples, the receiving device may transmit feedback using one of the channels 115, which may be used by a transmitting device (e.g., a host system 105, a memory system 110) to detect or correct one or more errors, for training operations, or both. Further, the receiving device may support multiplexing data for multiple channels over a single channel 115 if one or more other channels 115 experience failures in communications (e.g., if a threshold quantity of errors are detected in communications over other channels 115). In some cases, the receiving device may support reporting whether one or more errors are detected, may identify a failed pin associated with detected errors. Further, devices of the system 100 may support added redundancy via use of CRC bits or parity bits in transmitted data, or via error detection and correction at the devices.

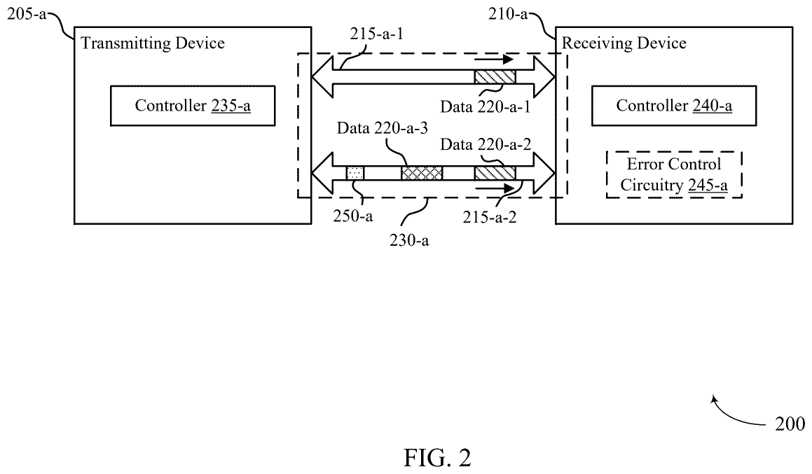

FIG. 2 shows an example of a system 200 that supports dedicated channels for data transmission in accordance with examples as disclosed herein. One or more aspects of the system 200 may implement or may be implemented by one or more aspects of the system 100. For example, the system 200 may include a transmitting device 205-a in communication with (e.g., coupled with) a receiving device 210-a via one or more channels 215, which may be examples of corresponding devices receiving data (e.g., memory systems 110, memory devices 145, host systems 105), devices transmitting data (e.g., host systems 105, memory systems 110, memory devices 145), and channels 115 as described herein with respect to FIG. 1. In some cases, the system 200 may support using one or more dedicated channels for data transmission as described herein.

For example, the transmitting device 205-a may be an example of a host system 105, and the receiving device 210-a may be an example of a memory system 110. In some examples, the memory system 110 may be or may include one or more memory devices 145 or modules (e.g., one or more DRAM devices, one or more NAND devices). In another example, the transmitting device 205-a may be a module while the receiving device 210-a may be a host system. Additionally, or alternatively, the transmitting device 205-a and the receiving device 210-a may be a same or similar type of devices (e.g., both host systems 105, both memory systems 110 or memory devices 145) or any combination of devices. Communications between the transmitting device 205-a and the receiving device 210-a may be performed via one or more channels 215 of one or more buses 230, such as a bus 230-a. Such channels 215 may correspond to different pins of the devices. For example, a channel 215 may be coupled with a DQ pin, a CA pin, or another pin, of a memory system 110 and/or host system 105. Further, the operations described herein may consider any quantity or combination of transmitting devices 205, receiving devices 210, and/or channels 215.

Each of the devices may include one or more respective controllers that may facilitate transmission and reception of data 220, error control operations, or both, among other operations and communications described herein. For example, the transmitting device 205-a may include a controller 235-a (e.g., a host system controller 150, a memory system controller 140, a local controller 150) and the receiving device 210-a may include a controller 240-a (e.g., a memory system controller 140, a local controller 150, a host system controller 150).

In some examples, data 220 (e.g., write data, read data, control signaling such as commands and/or addresses) transmitted via the channel 215-a-1 or stored at the receiving device 210-a may include one or more errors. For example, the transmitting device 205-a may transmit data 220-a-1 (e.g., data for one or more write operations) to the receiving device 210-a, which may store the data 220-a-1 in the receiving device 210-a. The data 220-a-1 may include one or more errors caused by transmission via the channel 215-a-1. For example, the channel 215-a-1 may be defective or otherwise cause an error (or errors) in the data 220-a-1, or the channel 215-a-1 may be coupled with a defective or otherwise failing or partially failing pin (e.g., a pin with a failing contact causing one or more errors). Additionally, or alternatively, such errors may be caused by environmental effects (e.g., temperature), or other factors. The receiving device 210-a may in some cases be delayed in performing one or more operations due to error correcting operations or retransmission performed to correct the errors, adding latency and reducing performance of the receiving device 210-a and/or one or more connected devices.

As described herein, the transmitting device 205-a and the receiving device 210-a may support (e.g., may be coupled with) one or more dedicated channels 215 to mitigate potential errors and/or failed pins or channels. In some examples, FIG. 2 may illustrate using one or more redundant channels in data transmissions. For example, the transmitting device 205-a may transmit, and the receiving device 210-a may receive, data 220-a-2 via a channel 215-a-2, where the channel 215-a-2 may be an example of a redundant channel or additional channel of the bus 230-a. In some examples, the receiving device 210-a may store the data 220-a-1 and the data 220-a-2 to one or more storage media (e.g., in DRAM memory of one or more memory devices, in NAND memory, in SRAM, in one or more registers, etc.).

Additionally, or alternatively, the channel 215-a-2 may represent or be a part of another bus (e.g., a redundant bus) separate from the bus 230-a. In some cases, a bus may be a collection of channels 215 and/or other components used in communication between one or more devices, including the transmitting device 205-a and the receiving device 210-a. In some examples, the data 220-a-2 may be a copy of the data 220-a-1. In some examples, a copy of data may represent a second set of data that is the same as or similar to a first set of data. In some cases, the data 220-a-2 may be transmitted concurrent with, at least partially concurrent with, or within a time window before or following, the transmission of the data 220-a-1. The channel 215-a-2 may be a redundant pin separate from a pin or other contact associated with the channel 215-a-1, or may include separate circuitry associated with a same pin as the channel 215-a-1.

In some examples, the receiving device 210-a may perform an error control operation on the data 220-a-1 and the data 220-a-2. For example, the receiving device 210-a may include error control circuitry 245-a that may be used to perform one or more error detection and/or error correction operations on the received data 220. In some cases, the operations may be performed on the data before or after storage, or after reading the data from storage. Error control operations may, in some cases involve comparing the data 220-a-1 with the data 220-a-2, where a quantity of errors may be detected based on determining one or more differences between the data 220-a-1 and the data 220-a-2 (e.g., a difference in one or more bits). Additionally, or alternatively, other error detection operations may be performed on each of the data 220-a-1 and the data 220-a-2. For example, the receiving device 210-a may perform one or more error detection and/or correction operations to detect a quantity of errors (e.g., single bit errors, double bit errors, correctable errors, uncorrectable errors) within each of the data 220-a-1 and the data 220-a-2.

The error detection and/or correction operations may in some cases include one or more CRC or parity operations, where the data 220-a-1 and the data 220-a-2 may each include one or more CRC bits or parity bits. The error control circuitry 245-a may also support one or more correction operations where errors may be corrected in the data 220 before or after storing the data to the receiving device 210-a. In some cases, the receiving device 210-a may include an error control circuitry 245-a per channel 215 or a shared circuitry for both channels 215. Additionally, or alternatively, the transmitting device 205-a may include error control circuitry configured to perform error control operations as described herein.

Some non-limiting examples of error control schemes may include various error correcting code (ECC) algorithms (e.g., ECC using single error correcting (SEC) codes, or SEC and double error detecting (SECDED) codes), Reed Solomon error correction, full single device data correction (SDDC) capable algorithms, among other examples. Each error control scheme may be further associated with one or more error control parameters such as a bit quantity, a parity-check matrix (e.g., an H matrix), an error detection type (e.g., adjacent errors, random errors, bit flip errors), and other parameters.

In some examples, the receiving device 210-a may select a channel 215 for communicating additional data 220-a-3 based on the error control operation. For example, if the receiving device 210-a detects a quantity of errors in the data 220-a-1 that satisfies (e.g., is greater than or equal to, is less than or equal to, exceeds a boundary of) a threshold value, and fails to detect one or more errors in the data 220-a-2 (or detects a greater quantity of errors within the data 220-a-1 compared to the data 220-a-2) the receiving device 210-a may select the channel 215-a-2. The receiving device 210-a may in some cases identify the channel 215-a-1 as a failed channel or as being associated with a failed pin based on the quantity errors satisfying the threshold value.

In another example, the receiving device 210-a may detect a same quantity of errors in both the data 220-a-1 and the data 220-a-2, and may select the channel 215-a-2 based on a stored parameter indicating the channel 215-a-2 for use. Additionally, or alternatively, the channel 215-a-2 may be selected based on the stored parameter if no errors are detected in either channel (e.g., the channel 215-a-2 may be a default channel). The stored parameter may in some cases be indicated in one or more received configurations (e.g., configurations received from the transmitting device 205-a) or may be previously stored at the receiving device 210-a (e.g., may be preconfigured during manufacturing operations). By way of another example, the receiving device 210-a may select the channel 215-a-1 for communicating the data 220-a-3 if a greater quantity of errors are detected within the data 220-a-2 compared to the data 220-a-1, or if no errors are detected within the data 220-a-1, or based on the parameter indicating the channel 215-a-1.

The receiving device 210-a and the transmitting device 205-a may communicate the data 220-a-3 using the selected channel 215. In some cases, the receiving device 210-a may receive the data 220-a-3 using both channels 215 and, if one of the channels 215 is selected, may deactivate the other channel, or otherwise ignore or discard data received via the other channel 215. In another example, the receiving device 210-a may transmit the data 220-a-3 using the selected channel 215 while refraining from transmitting the data in the non-selected channel 215. The transmitting device 205-a may similarly deactivate, ignore or otherwise discard received data, or refrain from transmitting data in the non-selected channel.

In some examples, the receiving device 210-a may, after detecting one or more errors, transmit an indication 250-a (e.g., may transmit a report) of the detected errors to the transmitting device 205-a. In some cases, the indication 250-a may indicate a detected quantity of errors. Additionally, or alternatively, the indication may indicate that one or more errors were detected in the data 220-a-2 (or within the data 220-a-1), may indicate that the channel 215-a-2 is selected for communication, or may indicate that the channel 215-a-1 is deactivated or ignored, or any combination thereof. For example, the indication 250-a may request or indicate to the transmitting device 205-a to use the channel 215-a-2 for communications, where the indication 250-a may enable the transmitting device 205-a to communicate the data 220-a-3. For example, based on the indication 250-a, the transmitting device 205-a may transmit the data 220-a-3 via the channel 215-a-2.

Including a redundant channel between devices, such as the channel 215-a-2, may improve information reliability by providing secondary method (e.g., a backup method) for communicating data, as well as providing for relatively faster error detection. For example, the receiving device 210-a may detect one or more errors associated with the channel 215-a-2 by comparing data between channels at an earlier time than errors may otherwise be detected without comparison, or than by using error detection operations on a single set of data. Error correction using CRC or parity bits may also increase a reliability of a single channel 215 by providing added redundancy within transmitted data 220 itself in addition to redundant channel use. In some cases, CRC or parity bits may represent a backup redundancy option (e.g., redundancy for data if a redundant channel is already in use or is not provided), and may further add flexibility in operations to be selected to increase reliability.

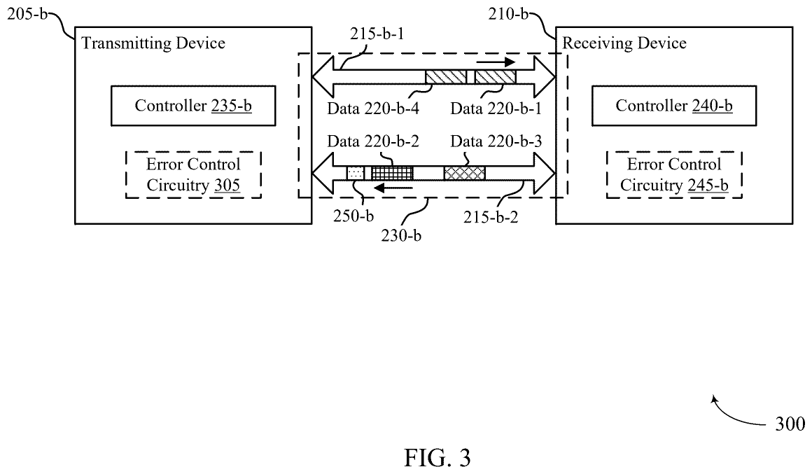

FIG. 3 shows an example of a system 300 that supports dedicated channels for data transmission in accordance with examples as disclosed herein. One or more aspects of the system 300 may implement or may be implemented by one or more aspects of the system 100 and the system 200. For example, the system 300 may include a transmitting device 205-b in communication with a receiving device 210-b via one or more channels 215 of a bus 230-b, which may be examples of the transmitting device 205-a, the receiving device 210-a, the channels 215, and the bus 230-a described herein with respect to FIG. 2. The transmitting device 205-b may also include a controller 235-b and the receiving device 210-b may include a controller 240-b and error control circuitry 245-b, which may represent examples of the controller 235-a, the controller 240-b, and the error control circuitry 245-a described herein with respect to FIGS. 2 and 3. In some cases, the system 300 may support feedback of data via one or more channels as described herein.

For example, after receiving data 220-b-1 via a channel 215-b-1 (e.g., a DQ channel, a CA channel), the receiving device 210-b may transmit data 220-b-2 via a channel 215-b-2. In some cases, the data 220-b-2 may include feedback associated with receiving the data 220-b-1. For example, the data 220-b-2 may represent a copy of the data 220-b-1 (e.g., a set of bits matching bits of the data 220-b-1) that may be transmitted back to the transmitting device 205-b to verify transmission or storage, or to be used in one or more operations at the transmitting device 205-b (e.g., at a host system 105). Additionally, or alternatively, the receiving device 210-b may perform one or more error control operations on the data 220-b-1, the data 220-b-2, or both, for example, using the error control circuitry 245-b.

In some examples, the transmitting device 205-b may perform an error control operation on the data 220-b-2. For example, the transmitting device 205-b may include error control circuitry 305 that may be used to perform one or more error detection and/or correction operations on the data 220-b-2, including CRC operations, parity operations, among other error detection and correction operations (e.g., ECC algorithms) as described herein with respect to FIG. 2. In some cases, the transmitting device 205-b may verify whether the data 220-b-1 was successfully transmitted and/or stored at the receiving device 210-b based on the feedback within the data 220-b-2. For example, if the data 220-b-2 matches the data 220-b-1 (e.g., each bit of the data 220-b-2 matches respective bits of the data 220-b-1), or if no errors are detected based on one or more error detection operations performed on the data 220-b-2, the transmitting device 205-b may determine that the data 220-b-1 was successfully transmitted to the receiving device 210-b, or that such data was successfully stored in one or more storage media.

In some examples, the transmitting device 205-b may determine one or more differences between the data 220-b-2 and the data 220-b-1 (e.g., a difference in one or more bits), or may detect one or more errors within the data 220-b-2 In some examples, the transmitting device 205-b may transmit data 220-b-4 via the channel 215-b-1 based on transmitting the data 220-b-1 and determining differences or detecting one or more errors during the error control operation. The data 220-b-4 may in some examples be a retransmission of the data 220-b-1. The receiving device 210-b may similarly transmit additional data 220 as feedback based on receiving the retransmission, and the transmitting device 205-b may perform an error control operation on the feedback. Further, the transmitting device 205-b may receive an indication 250-b that may indicate whether the receiving device 210-b detected one or more errors within the data 220-b-1 if error control is performed at the receiving device 210-b.

Additionally, or alternatively, the transmitting device 205-b may perform one or more training operations (e.g., a channel training operation) using the data 220-b-2. For example, the transmitting device 205-b may determine a timing or delay for one or more signals or algorithms for one or more channels 215 (e.g., perform write leveling, perform DQ strobe training) based on whether one or more errors are detected during the error control operation.

In some cases, the transmitting device 205-b may select the channel 215-a-2 based on a quantity of error control operations satisfying a threshold quantity of error control operations. For example, after a threshold quantity of error control operations have been performed, the transmitting device 205-b may perform both transmission and reception for data via the channel 215-b-2. In such a case, the transmitting device 205-b may identify the channel 215-b-1 as a failed channel (e.g., is associated with a failed pin), or determine to use another channel for data communication, based on continued detection of errors that may result in retransmissions. In some cases, selecting the channel 215-a-2 may be based on each of the error control operations of the quantity of error control operations satisfying a threshold value of errors. In some examples, the transmitting device 205-b and the receiving device 210-b may communicate data 220-b-3 via the channel 215-b-1 or the channel 215-b-2 after selecting a channel 215. In some cases, the transmitting device 205-b may select the channel 215-b-2 (or the channel 215-b-1) based on a quantity of errors detected in the data 220-b-2 satisfying a threshold quantity of errors after performing a single error control operation. The transmitting device 205-b may in some cases refrain from performing retransmissions of data. Additionally, or alternatively, the channels 215-a-1 and 215-b-1 may be used for redundant transmissions as described with respect to FIG. 2.

In some cases, transmitting a feedback signal via the data 220-b-2 may improve information reliability in communications. For example, performing error correction at a transmitting device 205-b and performing retransmissions may correct one or more errors within data, enabling error correction for modules that are unable to perform ECC operations. Further, selecting a channel based on detecting differences or errors at the transmitting device 205-b may reduce a quantity of errors in transmissions while reducing a quantity of retransmissions performed, which may reduce latency in communications between devices. Performing training operations using the data 220-b-2 may further reduce a quantity of errors in transmissions as well as a quantity of retransmissions to further improve performance.

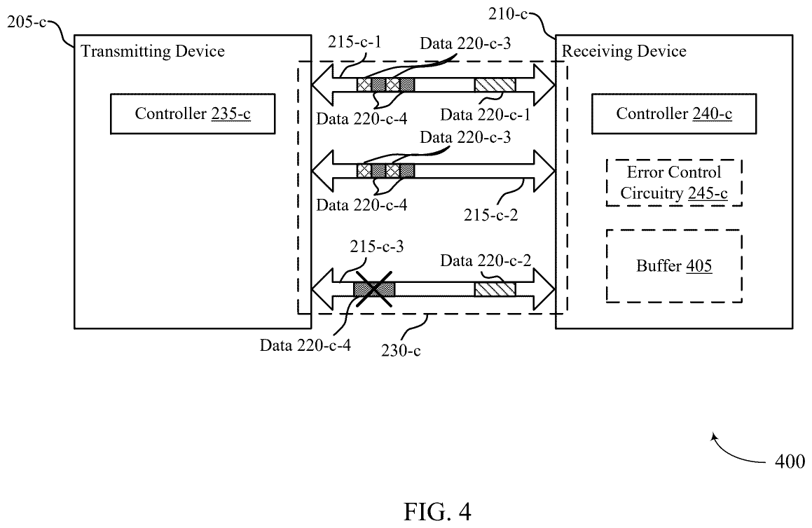

FIG. 4 shows an example of a system 400 that supports dedicated channels for data transmission in accordance with examples as disclosed herein. One or more aspects of the system 400 may implement or may be implemented by one or more aspects of the system 100 and the systems 200 and 300. For example, the system 400 may include a transmitting device 205-c in communication with (e.g., coupled with) a receiving device 210-c via one or more channels 215 of a bus 230-c, which may be examples of the transmitting devices 205, the receiving devices 210, the channels 215, and the buses 230 described herein with respect to FIGS. 2 and 3. The transmitting device 205-c may also include a controller 235-c and the receiving device 210-c may include a controller 240-c and error control circuitry 245-c, which may represent examples of the controllers 235, the controllers 240, and the error control circuitry 245 described herein with respect to FIGS. 2 and 3. In some cases, the system 400 may support multiplexing channel information on a single channel.

For example, the receiving device 210-c may receive data 220-a-1 (e.g., write data, read data, control signaling including one or more commands or addresses) via a channel 215-c-1 (e.g., a DQ channel, a CA channel). Additionally, or alternatively, the receiving device 210-c may receive data 220-c-2 via a channel 215-c-3 (e.g., the other of the DQ channel or CA channel, or another channel), where the channel 215-c-3 may be coupled with the transmitting device 205-c or with another device. In some examples, the receiving device 210-c may detect one or more errors within the data 220-c-2. For example, the receiving device 210-c may utilize the error control circuitry 245-c to perform one or more error detection and/or correction operations (e.g., ECC algorithms) as described herein, and may determine that a quantity of errors and/or quantity of error control operations satisfies one or more thresholds. In some cases, the receiving device 210-c may, in response to the one or more thresholds being satisfied, identify the channel 215-c-3 as a failed channel, or may determine to use another channel for data communication.

Based on detecting one or more errors, the receiving device 210-c may multiplex data for the channel 215-c-3 with data transmitted via another channel 215. For example, in place of communicating data 220-c-4 via the channel 215-c-3, the receiving device 210-c and the transmitting device 205-c may communicate the data 220-c-4 multiplexed with data 220-c-3 that is communicated via the channel 215-c-1. In some cases, to facilitate multiplexing of the data, the receiving device 210-c may store the data 220 that is waiting for transmission (e.g., read data, feedback) within a buffer 405 (or the transmitting device 205-c may similarly store data for transmission within a respective buffer or storage medium, such as for write data or commands). Data may in some cases be multiplexed using time division duplex (TDD) to slow down transmission while temporarily storing data 220 within a buffer such as the buffer 405. Additionally, or alternatively, data may be multiplexed using any multiplexing scheme, including frequency division duplex (FDD) and spatial multiplexing, among other techniques. In some cases, both the data 220-c-4 and the data 220-c-3 may be multiplexed and communicated via the channel 215-c-2 (e.g., via a redundant channel).

In some examples, the data 220-c-4 may be communicated via an available channel, such as the channel 215-c-2 (e.g., a redundant channel) while the data 220-c-3 may be communicated via the channel 215-c-1, or vice versa. Additionally, or alternatively, the channels 215-c-1, 215-c-2, and 215-c-3 may be used for redundant transmissions and/or feedback and retransmissions as described with respect to FIGS. 2 and 3, where the transmitting device 205-c may in some cases include error control circuitry. In some examples, multiplexing channel information on a single channel 215 may enable communication if one or more channels fail. Further, transmitting data on an available channel, such as a redundant channel, may enable continued communications in the case of channel failures.

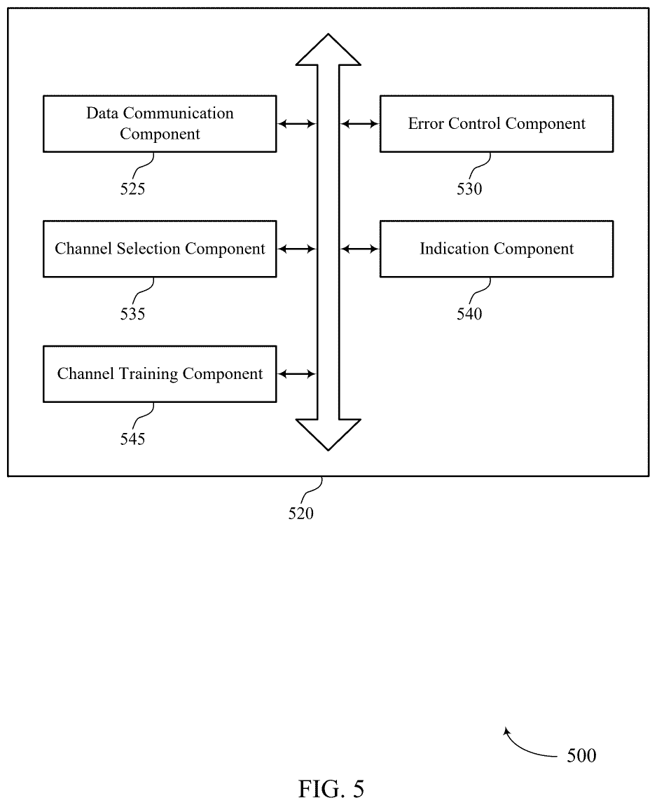

FIG. 5 shows a block diagram 500 of a memory system or host system 520 that supports dedicated channels for data transmission in accordance with examples as disclosed herein. The memory system or host system 520 may be an example of aspects of a memory system, a host system, a receiving device, or a transmitting device as described with reference to FIGS. 1 through 4. The memory system or host system 520, or various components thereof, may be an example of means for performing various aspects of dedicated channels for data transmission as described herein. For example, the memory system or host system 520 may include a data communication component 525, an error control component 530, a channel selection component 535, an indication component 540, a channel training component 545, or any combination thereof. Each of these components, or components of subcomponents thereof (e.g., one or more processors, one or more memories), may communicate, directly or indirectly, with one another (e.g., via one or more buses).

The data communication component 525 may be configured as or otherwise support a means for receiving first data via a first channel of a bus. In some examples, the data communication component 525 may be configured as or otherwise support a means for receiving second data via a second channel of the bus, the second data being a copy of the first data. The error control component 530 may be configured as or otherwise support a means for performing an error control operation on the first data and the second data. The channel selection component 535 may be configured as or otherwise support a means for selecting the second channel for communicating third data based at least in part on the error control operation detecting a quantity of errors in the first data that satisfies a threshold value.

In some examples, to support performing the error control operation, the error control component 530 may be configured as or otherwise support a means for comparing the first data with the second data, where the quantity of errors is detected based at least in part on determining that the first data is different than the second data.

In some examples, to support performing the error control operation, the error control component 530 may be configured as or otherwise support a means for detecting the quantity of errors associated with the first data. In some examples, to support performing the error control operation, the error control component 530 may be configured as or otherwise support a means for failing to detect one or more errors associated with the second data, where selecting the second channel is based at least in part on failing to detect the one or more errors associated with the second data.

In some examples, to support performing the error control operation, the error control component 530 may be configured as or otherwise support a means for detecting the quantity of errors associated with the first data. In some examples, to support performing the error control operation, the error control component 530 may be configured as or otherwise support a means for detecting a second quantity of errors associated with the second data, where selecting the second channel is based at least in part on the quantity of errors being greater than or equal to the second quantity of errors.

In some examples, the data communication component 525 may be configured as or otherwise support a means for receiving fourth data via the first channel. In some examples, the data communication component 525 may be configured as or otherwise support a means for receiving fifth data via the second channel. In some examples, the error control component 530 may be configured as or otherwise support a means for performing a second error control operation on the fourth data and the fifth data. In some examples, the channel selection component 535 may be configured as or otherwise support a means for selecting the second channel for communicating sixth data based at least in part on a parameter indicating the second channel and failing to detect one or more errors during the second error control operation.

In some examples, the indication component 540 may be configured as or otherwise support a means for transmitting an indication of the quantity of errors via the second channel. In some examples, the data communication component 525 may be configured as or otherwise support a means for communicating, via the second channel, the third data with a transmitting device based at least in part on transmitting the indication of the quantity of errors.

In some examples, the data communication component 525 may be configured as or otherwise support a means for receiving fourth data via the first channel. In some examples, the data communication component 525 may be configured as or otherwise support a means for transmitting fifth data via the second channel, where the fifth data includes feedback associated with receiving the fourth data.

In some examples, the data communication component 525 may be configured as or otherwise support a means for receiving sixth data via the first channel based at least in part on transmitting the fifth data, where the sixth data includes a retransmission of the fourth data.

In some examples, the third data is multiplexed with fourth data communicated via the second channel based at least in part on one or more errors associated with fifth data communicated via a third channel of the bus.

In some examples, selecting the second channel is based at least in part on a quantity of error control operations satisfying a threshold quantity of error control operations.

In some examples, the error control operation includes one or more cyclic redundancy checks. In some examples, the first data includes one or more first CRC bits and the second data includes one or more second CRC bits.

In some examples, the data communication component 525 may be configured as or otherwise support a means for transmitting first data via a first channel of a bus. In some examples, the data communication component 525 may be configured as or otherwise support a means for transmitting second data via a second channel of the bus. The indication component 540 may be configured as or otherwise support a means for receiving, via the second channel, an indication of a quantity of errors associated with the first data transmitted via the first channel. In some examples, the data communication component 525 may be configured as or otherwise support a means for communicating, via the second channel, third data based at least in part on the indication of the quantity of errors associated with the first data.

In some examples, the data communication component 525 may be configured as or otherwise support a means for transmitting fourth data via the first channel. In some examples, the data communication component 525 may be configured as or otherwise support a means for receiving fifth data via the second channel based at least in part on transmitting the fourth data, where the fifth data includes feedback associated with the fourth data.

In some examples, the channel training component 545 may be configured as or otherwise support a means for performing a channel training operation based at least in part on the fourth data and the fifth data.

In some examples, the error control component 530 may be configured as or otherwise support a means for performing an error control operation on the fifth data. In some examples, the data communication component 525 may be configured as or otherwise support a means for transmitting sixth data via the first channel based at least in part on a second quantity of errors detected during the error control operation, where the sixth data includes a retransmission of the fourth data.

In some examples, the third data is multiplexed with fourth data communicated via the second channel based at least in part on one or more errors associated with fifth data communicated via a third channel of the bus.

In some examples, the first data includes one or more first CRC bits and the second data includes one or more second CRC bits.

In some examples, the described functionality of the memory system or host system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system or host system 520, or various components thereof, may be implemented at least in part by instructions (e.g., stored in memory, non-transitory computer-readable medium) executable by such at least one processor.

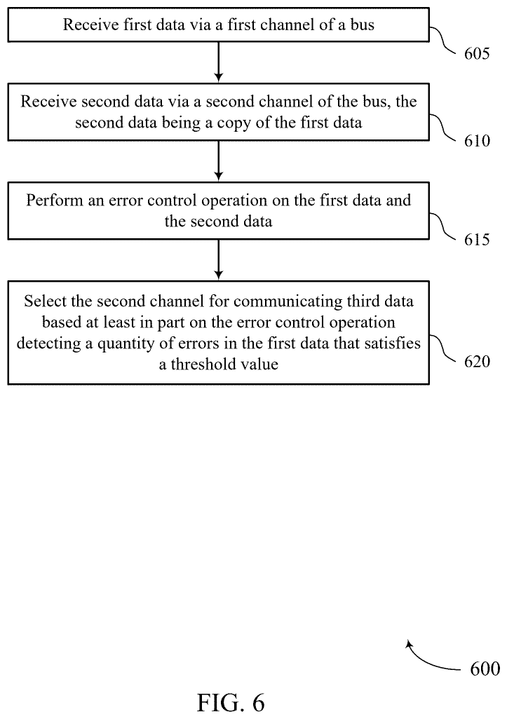

FIG. 6 shows a flowchart illustrating a method 600 that supports dedicated channels for data transmission in accordance with examples as disclosed herein. The operations of method 600 may be implemented by a memory system or a host system or its components as described herein. For example, the operations of method 600 may be performed by a memory system, a host system, or a receiving device as described with reference to FIGS. 1 through 5. In some examples, a memory system or a host system may execute a set of instructions to control the functional elements of the device to perform the described functions. Additionally, or alternatively, the memory system or the host system may perform aspects of the described functions using special-purpose hardware.

At 605, the method may include receiving first data via a first channel of a bus. In some examples, aspects of the operations of 605 may be performed by a data communication component 525 as described with reference to FIG. 5.

At 610, the method may include receiving second data via a second channel of the bus, the second data being a copy of the first data. In some examples, aspects of the operations of 610 may be performed by a data communication component 525 as described with reference to FIG. 5.

At 615, the method may include performing an error control operation on the first data and the second data. In some examples, aspects of the operations of 615 may be performed by an error control component 530 as described with reference to FIG. 5.

At 620, the method may include selecting the second channel for communicating third data based at least in part on the error control operation detecting a quantity of errors in the first data that satisfies a threshold value. In some examples, aspects of the operations of 620 may be performed by a channel selection component 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving first data via a first channel of a bus; receiving second data via a second channel of the bus, the second data being a copy of the first data; performing an error control operation on the first data and the second data; and selecting the second channel for communicating third data based at least in part on the error control operation detecting a quantity of errors in the first data that satisfies a threshold value.

Aspect 2: The method, apparatus, or non-transitory computer-readable medium of aspect 1, where performing the error control operation includes operations, features, circuitry, logic, means, or instructions, or any combination thereof for comparing the first data with the second data, where the quantity of errors is detected based at least in part on determining that the first data is different than the second data.

Aspect 3: The method, apparatus, or non-transitory computer-readable medium of any of aspects 1 through 2, where performing the error control operation includes operations, features, circuitry, logic, means, or instructions, or any combination thereof for detecting the quantity of errors associated with the first data and failing to detect one or more errors associated with the second data, where selecting the second channel is based at least in part on failing to detect the one or more errors associated with the second data.

Aspect 4: The method, apparatus, or non-transitory computer-readable medium of any of aspects 1 through 3, where performing the error control operation includes operations, features, circuitry, logic, means, or instructions, or any combination thereof for detecting the quantity of errors associated with the first data and detecting a second quantity of errors associated with the second data, where selecting the second channel is based at least in part on the quantity of errors being greater than or equal to the second quantity of errors.

Aspect 5: The method, apparatus, or non-transitory computer-readable medium of any of aspects 1 through 4, further including operations, features, circuitry, logic, means, or instructions, or any combination thereof for receiving fourth data via the first channel; receiving fifth data via the second channel; performing a second error control operation on the fourth data and the fifth data; and selecting the second channel for communicating sixth data based at least in part on a parameter indicating the second channel and failing to detect one or more errors during the second error control operation.

Aspect 6: The method, apparatus, or non-transitory computer-readable medium of any of aspects 1 through 5, further including operations, features, circuitry, logic, means, or instructions, or any combination thereof for transmitting an indication of the quantity of errors via the second channel and communicating, via the second channel, the third data with a transmitting device based at least in part on transmitting the indication of the quantity of errors.

Aspect 7: The method, apparatus, or non-transitory computer-readable medium of any of aspects 1 through 6, further including operations, features, circuitry, logic, means, or instructions, or any combination thereof for receiving fourth data via the first channel and transmitting fifth data via the second channel, where the fifth data includes feedback associated with receiving the fourth data.

Aspect 8: The method, apparatus, or non-transitory computer-readable medium of aspect 7, further including operations, features, circuitry, logic, means, or instructions, or any combination thereof for receiving sixth data via the first channel based at least in part on transmitting the fifth data, where the sixth data includes a retransmission of the fourth data.

Aspect 9: The method, apparatus, or non-transitory computer-readable medium of any of aspects 1 through 8, where the third data is multiplexed with fourth data communicated via the second channel based at least in part on one or more errors associated with fifth data communicated via a third channel of the bus.

Aspect 10: The method, apparatus, or non-transitory computer-readable medium of any of aspects 1 through 9, where selecting the second channel is based at least in part on a quantity of error control operations satisfying a threshold quantity of error control operations.

Aspect 11: The method, apparatus, or non-transitory computer-readable medium of any of aspects 1 through 10, where: the error control operation includes one or more cyclic redundancy checks, the first data includes one or more first CRC bits, and the second data includes one or more second CRC bits.

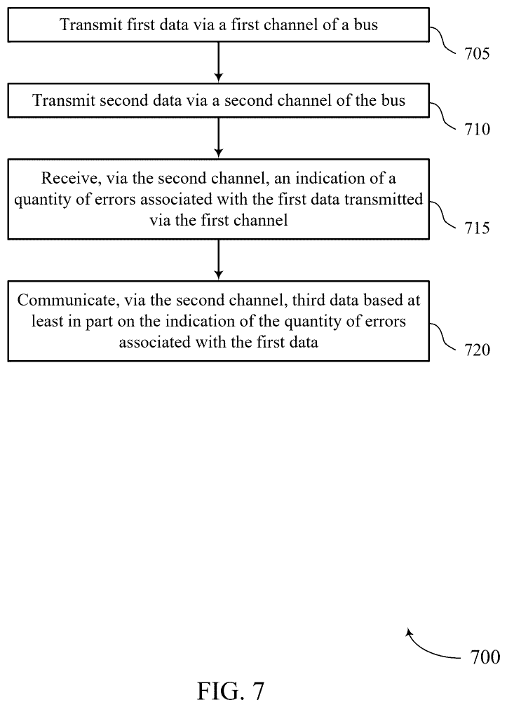

FIG. 7 shows a flowchart illustrating a method 700 that supports dedicated channels for data transmission in accordance with examples as disclosed herein. The operations of method 700 may be implemented by a memory system or a host system or its components as described herein. For example, the operations of method 700 may be performed by a memory system, a host system, or a transmitting device as described with reference to FIGS. 1 through 5. In some examples, a memory system or a host system may execute a set of instructions to control the functional elements of the device to perform the described functions. Additionally, or alternatively, the memory system or the host system may perform aspects of the described functions using special-purpose hardware.

At 705, the method may include transmitting first data via a first channel of a bus. In some examples, aspects of the operations of 705 may be performed by a data communication component 525 as described with reference to FIG. 5.

At 710, the method may include transmitting second data via a second channel of the bus. In some examples, aspects of the operations of 710 may be performed by a data communication component 525 as described with reference to FIG. 5.

At 715, the method may include receiving, via the second channel, an indication of a quantity of errors associated with the first data transmitted via the first channel. In some examples, aspects of the operations of 715 may be performed by an indication component 540 as described with reference to FIG. 5.

At 720, the method may include communicating, via the second channel, third data based at least in part on the indication of the quantity of errors associated with the first data. In some examples, aspects of the operations of 720 may be performed by a data communication component 525 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 12: A method, apparatus, or non-transitory computer-readable medium including operations, features, circuitry, logic, means, or instructions, or any combination thereof for transmitting first data via a first channel of a bus; transmitting second data via a second channel of the bus; receiving, via the second channel, an indication of a quantity of errors associated with the first data transmitted via the first channel; and communicating, via the second channel, third data based at least in part on the indication of the quantity of errors associated with the first data.

Aspect 13: The method, apparatus, or non-transitory computer-readable medium of aspect 12, further including operations, features, circuitry, logic, means, or instructions, or any combination thereof for transmitting fourth data via the first channel and receiving fifth data via the second channel based at least in part on transmitting the fourth data, where the fifth data includes feedback associated with the fourth data.

Aspect 14: The method, apparatus, or non-transitory computer-readable medium of aspect 13, further including operations, features, circuitry, logic, means, or instructions, or any combination thereof for performing a channel training operation based at least in part on the fourth data and the fifth data.

Aspect 15: The method, apparatus, or non-transitory computer-readable medium of any of aspects 13 through 14, further including operations, features, circuitry, logic, means, or instructions, or any combination thereof for performing an error control operation on the fifth data and transmitting sixth data via the first channel based at least in part on a second quantity of errors detected during the error control operation, where the sixth data includes a retransmission of the fourth data.

Aspect 16: The method, apparatus, or non-transitory computer-readable medium of any of aspects 12 through 15, where the third data is multiplexed with fourth data communicated via the second channel based at least in part on one or more errors associated with fifth data communicated via a third channel of the bus.

Aspect 17: The method, apparatus, or non-transitory computer-readable medium of any of aspects 12 through 16, where: the first data includes one or more first CRC bits, and the second data includes one or more second CRC bits.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A receiving device, comprising:
one or more memory arrays; and
processing circuitry coupled with the one or more memory arrays and configured to cause the receiving device to:
receive first data via a first channel of a bus;
receive second data via a second channel of the bus, the second data being a copy of the first data;
perform an error control operation on the first data and the second data; and
select the second channel for communicating third data based at least in part on the error control operation detecting a quantity of errors in the first data that satisfies a threshold value.

2. The receiving device of claim 1, wherein performing the error control operation comprises the processing circuitry configured to cause the receiving device to:
compare the first data with the second data, wherein the quantity of errors is detected based at least in part on determining that the first data is different than the second data.

3. The receiving device of claim 1, wherein performing the error control operation comprises the processing circuitry configured to cause the receiving device to:
detect the quantity of errors associated with the first data; and
fail to detect one or more errors associated with the second data, wherein selecting the second channel is based at least in part on failing to detect the one or more errors associated with the second data.

4. The receiving device of claim 1, wherein performing the error control operation comprises the processing circuitry configured to cause the receiving device to:
detect the quantity of errors associated with the first data; and
detect a second quantity of errors associated with the second data, wherein selecting the second channel is based at least in part on the quantity of errors being greater than or equal to the second quantity of errors.

5. The receiving device of claim 1, wherein the processing circuitry is further configured to cause the receiving device to:
receive fourth data via the first channel;
receive fifth data via the second channel;
perform a second error control operation on the fourth data and the fifth data; and
select the second channel for communicating sixth data based at least in part on a parameter indicating the second channel and failing to detect one or more errors during the second error control operation.

6. The receiving device of claim 1, wherein the processing circuitry is further configured to cause the receiving device to:
transmit an indication of the quantity of errors via the second channel; and
communicate, via the second channel, the third data with a transmitting device based at least in part on transmitting the indication of the quantity of errors.

7. The receiving device of claim 1, wherein the processing circuitry is further configured to cause the receiving device to:
receive fourth data via the first channel; and
transmit fifth data via the second channel, wherein the fifth data comprises feedback associated with receiving the fourth data.

8. The receiving device of claim 7, wherein the processing circuitry is further configured to cause the receiving device to:
receive sixth data via the first channel based at least in part on transmitting the fifth data, wherein the sixth data comprises a retransmission of the fourth data.

9. The receiving device of claim 1, wherein the third data is multiplexed with fourth data communicated via the second channel based at least in part on one or more errors associated with fifth data communicated via a third channel of the bus.

10. The receiving device of claim 1, wherein selecting the second channel is based at least in part on a quantity of error control operations satisfying a threshold quantity of error control operations.

11. The receiving device of claim 1, wherein:
the error control operation comprises one or more cyclic redundancy checks,
the first data comprises one or more first cyclic redundancy check bits, and
the second data comprises one or more second cyclic redundancy check bits.

12. A transmitting device, comprising:
processing circuitry associated with one or more memory devices and configured to cause the transmitting device to:
transmit first data via a first channel of a bus;
transmit second data via a second channel of the bus;
receive, via the second channel, an indication of a quantity of errors associated with the first data transmitted via the first channel; and
communicate, via the second channel, third data based at least in part on the indication of the quantity of errors associated with the first data.

13. The transmitting device of claim 12, wherein the processing circuitry is further configured to cause the transmitting device to:
transmit fourth data via the first channel; and
receive fifth data via the second channel based at least in part on transmitting the fourth data, wherein the fifth data comprises feedback associated with the fourth data.

14. The transmitting device of claim 13, wherein the processing circuitry is further configured to cause the transmitting device to:
perform a channel training operation based at least in part on the fourth data and the fifth data.

15. The transmitting device of claim 13, wherein the processing circuitry is further configured to cause the transmitting device to:
perform an error control operation on the fifth data; and
transmit sixth data via the first channel based at least in part on a second quantity of errors detected during the error control operation, wherein the sixth data comprises a retransmission of the fourth data.

16. The transmitting device of claim 12, wherein the third data is multiplexed with fourth data communicated via the second channel based at least in part on one or more errors associated with fifth data communicated via a third channel of the bus.

17. The transmitting device of claim 12, wherein:
the first data comprises one or more first cyclic redundancy check bits, and
the second data comprises one or more second cyclic redundancy check bits.

18. A method by a receiving device, comprising:
receiving first data via a first channel of a bus;
receiving second data via a second channel of the bus, the second data being a copy of the first data;
performing an error control operation on the first data and the second data; and
selecting the second channel for communicating third data based at least in part on the error control operation detecting a quantity of errors in the first data that satisfies a threshold value.

19. The method of claim 18, wherein performing the error control operation comprises:
comparing the first data with the second data, wherein the quantity of errors is detected based at least in part on determining that the first data is different than the second data.

20. The method of claim 18, wherein performing the error control operation comprises:
detecting the quantity of errors associated with the first data; and
failing to detect one or more errors associated with the second data, wherein selecting the second channel is based at least in part on failing to detect the one or more errors associated with the second data.

21. The method of claim 18, wherein performing the error control operation comprises:
detecting the quantity of errors associated with the first data; and
detecting a second quantity of errors associated with the second data, wherein selecting the second channel is based at least in part on the quantity of errors being greater than or equal to the second quantity of errors.

22. The method of claim 18, further comprising:
receiving fourth data via the first channel;
receiving fifth data via the second channel;
performing a second error control operation on the fourth data and the fifth data; and
selecting the second channel for communicating sixth data based at least in part on a parameter indicating the second channel and failing to detect one or more errors during the second error control operation.

23. The method of claim 18, further comprising:
transmitting an indication of the quantity of errors via the second channel; and
communicating, via the second channel, the third data with a transmitting device based at least in part on transmitting the indication of the quantity of errors.

24. The method of claim 18, further comprising:
receiving fourth data via the first channel; and
transmitting fifth data via the second channel, wherein the fifth data comprises feedback associated with receiving the fourth data.

25. The method of claim 24, further comprising:
receiving sixth data via the first channel based at least in part on transmitting the fifth data, wherein the sixth data comprises a retransmission of the fourth data.
